(19) United States
(12) Patent Application Publication
(10) Pub. No.: US 2008/0110359 A1
(43) Pub. Date: May 15, 2008

(54) Plate making method, printing plate image output apparatus, image editing apparatus and printing plate image output system

(75) Inventor: Kazuhiro Oikawa, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Konica Minolta Medical & Graphic, Inc., Tokyo (JP)

(21) Appl. No.: 11/975,934

(22) Filed: Oct. 23, 2007

(30) Foreign Application Priority Data
Oct. 31, 2006 (JP) JP2006-295647

(51) Int. Cl. B41C 3/00

(52) U.S. Cl. 101/401.1

(57) ABSTRACT

A plate making method for making a printing plate from a printing plate material, this plate making method including an image output process for outputting an image onto the printing plate material in conformity to the first control strip image data which form a pseudo gradation in the two-dimensional direction having the density gradation in the longitudinal direction and the second control strip image data which form a pseudo gradation being different from the abovementioned pseudo gradation in the two-dimensional direction and having a uniform density in the longitudinal direction, and an image forming process for forming on this printing plate an image 1 based on the first control strip image data, and an image 2 based on the second control strip image data.

This application is based on Japanese Patent Application No. 2006-295647 filed on Oct. 31, 2006 in Japanese Patent Office, the entire content of which is hereby incorporated by reference.

### BACKGROUND OF THE INVENTION

The present invention relates to a plate making method, a printing plate image output apparatus, an image editing apparatus, and a printing plate image output system which are intended to be used to manage a plate making process for making a printing plate by producing a plate from a printing plate material.

In the printing plate manufacturing technique for planography, there has been widespread use of a CTP (Computer to Plate) system in recent years, wherein a printing plate material is directly exposed to a laser beam source and the digital data of an image is transferred onto the printing plate material.

The CTP system uses a method of managing the plate making process for producing a printing plate by exposure and development of a printing plate material. This method is exemplified by the conventionally known technique wherein both the image having smaller variation in image area ratio according to the processing conditions (process independent) and the image having greater variation in this (process dependent) are outputted in parallel, and are compared, whereby the variation in the plate making conditions is detected.

For example, a process independent strip having graduations and a process dependent strip having a predetermined density are used. Based on the fact that the position wherein their densities agree with each other (equi-density position) varies according to the change in the processing condition, this equi-density position is observed and evaluated, whereby process management is performed (Patent Document 1). In another example, a method is known wherein an image whose image area ratio exhibits an stepwise change of 25%, 30%, 35%, 40%, 45%, 50%, 55%, 60%, 65% and 70%, as the process independent strip for example, and a process dependent image having a predetermined density are used (Patent Document 2).

However, in these methods, the pattern used in the process independent strip has a stepwise gradation or a uni-directional (one-dimensional) gradation alone. It is difficult to represent a smooth graduation in the limited area of non-image portion of the printing plate, and accurate equi-density position cannot be determined. Thus, it has been difficult to ensure stable printing of printed matter and, in particular, to maintain the stable quality of the printed matter having a high definition image.

[Patent Document 1] Unexamined Japanese Patent Application Publication No. 9-505678

[Patent Document 2] Unexamined Japanese Patent Application Publication No. 10-191045

### SUMMARY

An object of the present invention is to provide a plate making method, printing plate image output apparatus, image editing apparatus, and printing plate image output system capable of producing a printing plate that ensures stable printing quality of printed matter and, in particular, maintains the stable quality of the printed matter having a high definition image.

The aforementioned object can be achieved by the following structures.

A plate making method for making a printing plate from a printing plate material, which includes

an image output process for outputting an image onto the printing plate material in conformity to the first control strip image data which form a pseudo gradation in the two-dimensional direction having density gradation in the longitudinal direction and the second control strip image data which form a pseudo gradation being different from the abovementioned pseudo gradation in the two-dimensional direction and having a uniform density in the longitudinal direction, and

an image forming process for forming on this printing plate an image 1 based on the first control strip image data, and an image 2 based on the second control strip image data.

### BRIEF DESCRIPTION OF THE DRAWINGS

FIG. 1 is a schematic diagram representing an example of the structure of the printing plate image output system of the present invention;

FIG. 2 is a schematic pattern representing an example of the image formed on the printing plate;

FIG. 3 is a block diagram representing the image editing apparatus;

FIG. 4 is a block diagram representing the screening apparatus; and

FIG. 5 is a block diagram representing the printing plate image output apparatus.

### DETAILED DESCRIPTION OF THE PREFERRED EMBODIMENT

The following describes the embodiment of the present invention:

(1) The aforementioned plate making method wherein the aforementioned image output process is an image output process for outputting an image based on the image data of a printing document, in addition to the aforementioned first control strip image data and second control strip image data; and the aforementioned image forming process is an image forming process for forming an image 3 based on this printing document data, in addition to the aforementioned image 1 and image 2.

(2) The aforementioned plate making method wherein the aforementioned image output process is an image output process for outputting an image based on the scale image data, in addition to the aforementioned first control strip image data and second control strip image data; and the aforementioned image forming process is an image forming process for forming an image 4 based on this scale image data, in addition to the aforementioned image 1 and image 2.

(3) The aforementioned plate making method wherein the aforementioned image 1 and the aforementioned image 2 are adjacent to each other perpendicularly to the longitudinal direction.

(4) The aforementioned plate making method wherein the aforementioned image 4 is adjacent to either the aforementioned image 1 or image 2.

(5) The aforementioned plate making method wherein the aforementioned image 1 and the aforementioned image 2 are located in the non-image area of the aforementioned printing plate.

(6) The aforementioned plate making method wherein the aforementioned first control strip image data, the aforementioned second control strip image data and the aforementioned printing document image data are the image data of raster format, and the aforementioned image is outputted by the image output apparatus based on the image data of raster format.

(7) The aforementioned plate making method wherein the image data of the aforementioned raster format is the image data converted into a raster format by an image screening apparatus from the vector format edited by the image editing apparatus.

(8) A printing plate image output apparatus used for the plate making method described in (6) wherein an image is outputted based on raster format image data including

the first control strip image data which form a pseudo gradation in the two-dimensional direction having density gradation in the longitudinal direction,

the second control strip image data which form a pseudo gradation being different from the abovementioned pseudo gradation in the two-dimensional direction and having a uniform density in the longitudinal direction, and

printing document image data.

(9) A image editing apparatus used for the plate making method described in (7) wherein printing document image data is provided with the first control strip image data which form a pseudo gradation in the two-dimensional direction having density gradation in the longitudinal direction, and the second control strip image data which form a pseudo gradation being different from the above-mentioned pseudo gradation in the two-dimensional direction and having a uniform density in the longitudinal direction.

(10) A printing plate image output system including

an image editing apparatus for editing image data;

an screening apparatus for converting the image data edited by the image editing apparatus, and

an image output apparatus for outputting the image based on the image data having been converted,

wherein the image output apparatus is the printing plate image output apparatus described in (8).

(11) A printing plate image output system including:

an image editing apparatus for editing image data;

an screening apparatus for converting the image data edited by the image editing apparatus, and

an image output apparatus for outputting the image based on the image data having been converted,

wherein the image editing apparatus is the image editing apparatus described in (9).

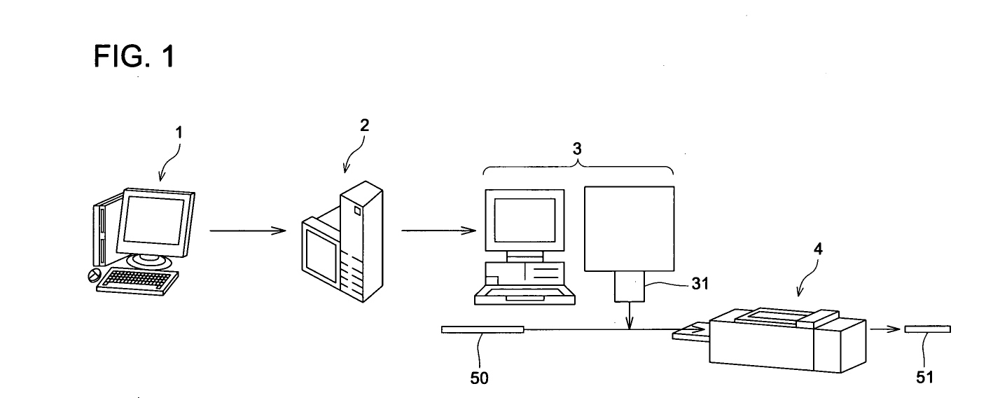

Referring to drawings, the following describes the best form of embodiment of the present invention. FIG. 1 is a schematic diagram representing an example of the structure of the printing plate image output system of the present invention.

In FIG. 1, the reference numeral 1 is an image editing apparatus, 2 is a screening apparatus, and 3 is a printing plate image output apparatus.

In the plate making method of the present invention, a printing plate material 50 is made into a printing plate 51 by the step of being exposed by an exposure section 31 of the printing plate image output apparatus 3 for imaging and being developed by an automatic development apparatus 4.

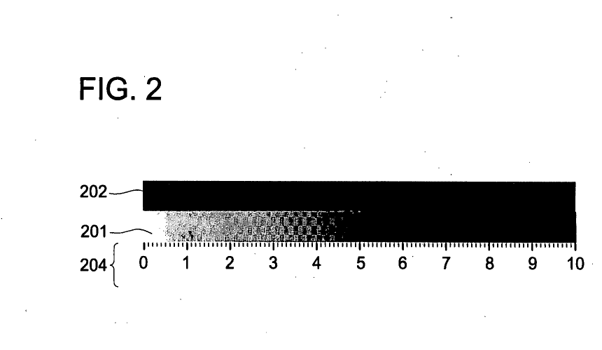

FIG. 2 is a pattern diagram representing an example of the image formed on the printing plate 51. The reference numeral 201 is image 1, 202 is image 2, and 204 is image 4, all relating to the present invention.

The image 1 (201) is outputted (exposed) onto the printing plate material 50 by the exposure section 31 and is developed, in conformity to the first control strip image data containing the density gradation in the longitudinal direction, which is a pseudo gradation in the two-dimensional direction.

The image 2 (202) is outputted (exposed) onto the printing plate material 50 by the exposure section 31 and is developed, in conformity to the second control strip image data having a predetermined density in the longitudinal direction, which is a pseudo gradation different from the abovementioned pseudo gradation in the two-dimensional direction.

The image based on the first control strip image data is a continuous gradation image wherein the density gradation as a pseudo gradation in the two-dimensional direction is represented in the longitudinal direction. The dot images of various numbers of lines and shapes can be used as the image of pseudo gradation in the two-dimensional direction.

The image based on the second control strip image data is an image having a predetermined density uniformly also in the longitudinal direction, which is a pseudo gradation different from the abovementioned pseudo gradation in the two-dimensional direction.

The halftone dot images of various numbers of lines and shapes can be used as the image having the pseudo gradation in the two-dimensional direction different from the above pseudo gradation in the two-dimensional direction. However, number of lines or halftone dot shape is different from one of the first control strip image data.

The halftone dot images having different numbers of lines and shapes signify that the image 1 and image 2 are different in the size of the change in the image area ratio due to the variation in the plate making condition. It means use of the image having a smaller variation in the image area ratio according to the variation of the plate making condition (process independent) or the image having a greater variation in the image area ratio (process dependent). In the present invention, the image 1 having a continuous gradation and the image 2 having a uniform density are viewed in parallel, whereby the position (equi-density position) wherein the density of the image 1 agrees with that of the image 2 is specified. Since this equi-density position changes depending on the variation in the plate making condition, the variation in the plate making condition can be detected.

In the present invention, in particular, both the image based on the second control strip image data and the image based on the first control strip image data are pseudo gradation images in the two-dimensional direction, and they are different pseudo gradation images. This arrangement ensures high-precision detection of the variation in plate making conditions such as exposure and development.

In the present invention, it is preferred in particular that the image 1 is a process dependent image and the image 2 is a process independent image.

The condition of the image 1 being a process dependent image and the image 2 being a process independent image is used, for example, when a two-dimensional continuous gradation image based on the FM screen characterized by 20 μm dots equivalent to 385 lines is used as the image 1, and 8-pixel square checker board of a 2400 dpi (where dpi indicates the number of dots per inch) is used as the image 2.

In this case, the outer peripheral length per 1×1 line in halftone is about 187 μm for the image 201 based on the first control strip image data, and is 103 μm or more for the image 202 based on the second control strip image data. The image 201 based-on the first control strip image data has a greater variation in visual density of the image resulting from process variation.

The density of the image 2 having a predetermined density is preferably in the range of 35 through 85% in terms of halftone dot area ratio, more preferably in the range of 40 through 60%, still more preferably in the range of 45 through 55%.

To view the equi-density position of the image 1 and image 2, an image 4 by the scale image data as well as the image 1 and image 2 are preferably formed on the printing plate.

The image 1 and image 2 are preferably adjacent to each other in the vertical direction to the longitudinal direction. Further, an image 4 is preferably adjacent to either the adjacent image 1 or image 2. The aforementioned image 1 (201) and image 2 (202) in FIG. 2 are adjacent to each other. Further, the image 4 as a scale image is adjacent to the image 1.

The scale image of the image 4 has a scale wherein both ends of the gradation are divided preferably into ten equal parts, more preferably in twenty equal parts, still more preferably 100 equal parts. The scale is preferably assigned with numerals according to the requirements.

The image 1, image 2 and image 4, together with the image 3 based on the image data (printing document data) which is for an object of printing, may be formed on the printing plate. In this case, the image 1 and image 2 are preferably formed in the non-image area of the image 3 which is based on the printing document data. For example, it is preferably formed in the area of the printing plate called “a holding part”.

The total size of the control strip images of the image 1 and image 2 is preferably in the range of 10 mm×100 mm through 20 mm×200 mm, more preferably in the range of 15 mm×180 mm through 20 mm×200 mm. For example, the sizes of 15 mm×200 mm and 10 mm×150 mm are preferred.

In the plate making method of the present invention, variation in the conditions of the plate making process can be detected and managed by viewing the image 1 and image 2.

To detect and manage the variation, steps are taken to cause variation in the plate making conditions, and to measure the percentage of the variation of the equi-density position and of the performances such as the reproducibility of halftone dots in advance, in response to the variation in the plate making conditions. The equi-density position under the plate making condition as the object is measured, and the result of this measurement is compared with the equi-density position under the standard conditions obtained in advance.

For example, assume the case of the image quality of the printed matter having been outputted on the FM screen (20 μm dot) equivalent to 385 lines with a resolution of 2400 dpi. When management is intended to ensure that a 50% halftone dot density is kept within 2% variation range which cannot be easily identified by ordinary people, the control range exhibits a variation of about 5 in terms of the scale value when each image is equally divided into 100 parts, if an image of continuous gradation in the two-dimensional direction in the range of 35 through 85% is used as the aforementioned image 1 (201) and an eight-pixel square checker board is used as the image 2 (202).

If the difference value as compared with the equi-density value under the standard condition is kept within this control range (5 in terms of scale value), it is assumed that the process conditions are satisfied, and the outputted printing plate is directly mounted on a printing machine to perform printing operation. When the smaller scale values of the image 4 (204) as a scale image are set on the lower density side of the image 1 (201), a reduction in the amount of exposure resulting from the laser deterioration of the exposure apparatus or excessive replenishment of developer may be considered, if the lower limit of this control range has been exceeded, for example, the variation of the equi-density position is greater than 5 and smaller than the equi-density value under the standard condition. To ensure that the variation of the equi-density position will be kept within the control range, steps are taken to increase the setting amount of exposure by making reference to the percentage of variation obtained in advance, or replace the liquid developer.

Conversely, when the control range has been exceeded, for example, when the variation of the equi-density position is greater than 5 and is greater than the equi-density value under the standard condition, fatigue of the liquid developer or reduction of development temperature may be considered. To ensure that the variation of the equi-density position is kept within the control range, steps are taken to replenish the liquid developer or to increase the development temperature.

When the equi-density position is specified in the present invention, the equi-density position can be specified within a narrower range. This ensures high-precision detection and management of the variation in plate making conditions, and allows plate making conditions to be kept within a smaller variation range, with the result that a printed matter of more stable quality and a smaller variation in halftone dot area ratio can be produced.

(Image Output Apparatus and Image Editing Apparatus)

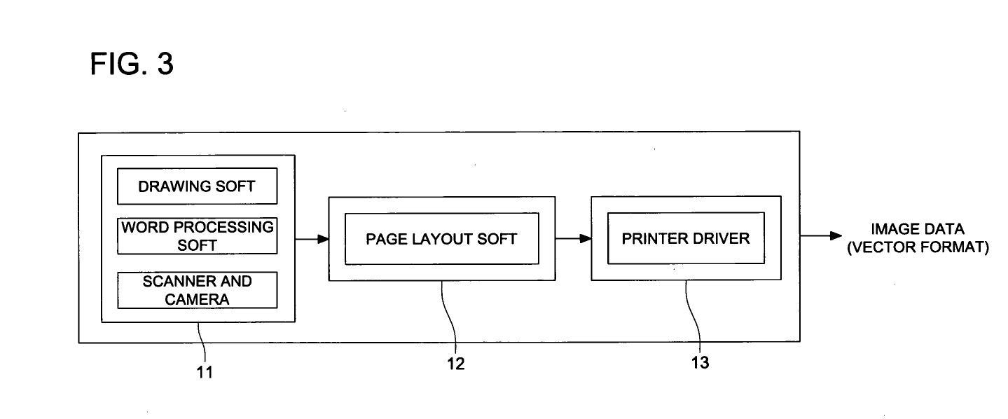

FIG. 3 is a block diagram representing the image editing apparatus of FIG. 1. The reference numeral 11 is an image information input section, 12 is an image editing section, 13 is a data output section for outputting the edited image in a vector format.

Image information is converted into data by the image information input section 11, and is edited by the image editing section. It is converted into vector format image data before or after editing, whenever required. The vector format image data is outputted to the screening apparatus from the data output section 13.

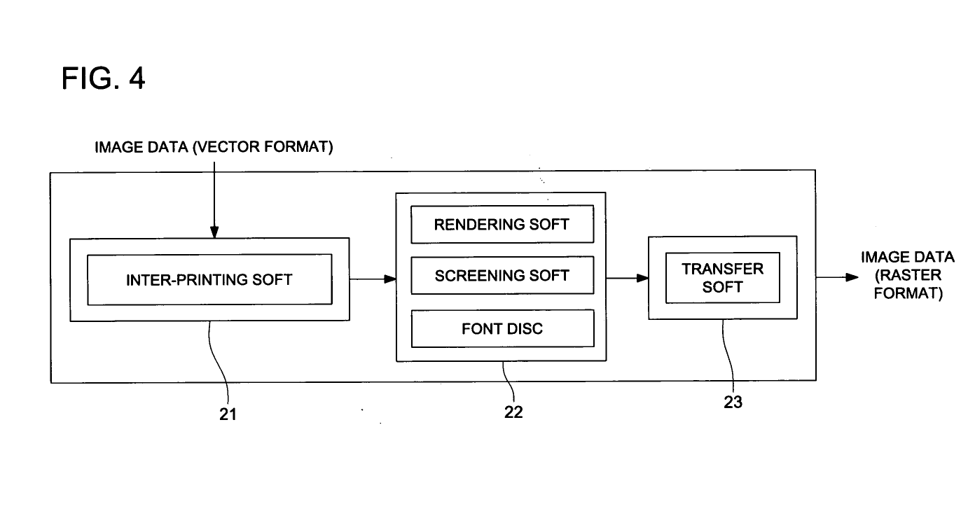

FIG. 4 is a block diagram representing the screening apparatus of FIG. 1. The reference numeral 21 is an input section from the image editing apparatus, 22 is a converting section for converting the image data into halftone dot data, and the vector format image data into raster format image data, whenever required. The reference numeral 23 is an output section for outputting the image data having been converted into the raster format image data.

The vector format image data outputted from the image editing apparatus is edited by the data converting section 22, is converted into the raster format, and is outputted from the data output section 23.

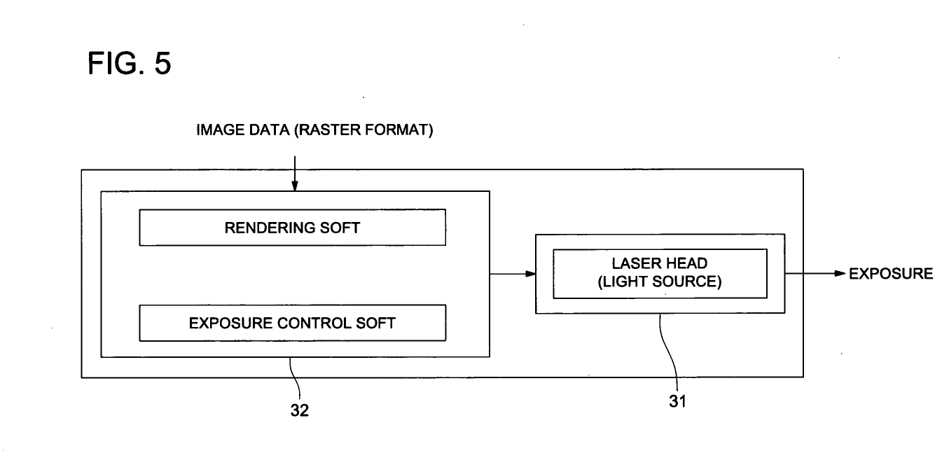

FIG. 5 is a block diagram representing the image output apparatus of FIG. 1. The reference numeral 32 is a control section, 31 is an exposure section. The raster format image data having been outputted from the screening apparatus is sent to the control section 32 and is converted into the image data for exposure. The data is then sent to the exposure section 31, and exposure is conducted by the light source.

In the image output process in the present invention, the image is outputted based on the first control strip image data and second control strip image data. In the presence of the printing document image data, scale image data, the image is outputted based on the printing document image data and scale image data at the same time.

The first control strip image data, second control strip image data, printing document image data, scale image data for image output are raster format image data, and are sent to the exposure section 31 of the printing plate image output apparatus 3, where exposure is carried out based on the raster format image data.

The raster format image data is the image data having been converted by the converting section 22 of the screening apparatus 2 from the vector format image having been edited by the image editing apparatus 1.

In the image editing apparatus 1, the image editing section 12 performs the editing operation wherein, for example, in the vector format the first control strip image data and second control strip image data is attached to the printing document image data and the scale image data is placed adjacent to the first control strip image data or second control strip image data.

What is called the raster format here refers to the pixel set data wherein the image is represented as dot information. This data allows scanning exposure to be achieved. TIFF, BMP, GIF and JPEG codes are available for the raster format.

The vector format is the format of the data wherein an image is represented in terms of page description language, as exemplified by the format described in the post-script. To permit the image to be outputted (scanning exposure) on the printing plate material, the data must be converted into the aforementioned raster format.

### EXAMPLE

The following specifically describes the present invention, without the embodiment of the present invention being restricted thereto. The terms “part” and “%” in the Example refer to “part by mass” and “% by mass” unless otherwise specified.

(Manufacturing the Printing Plate Material)

(Synthesis of Binder)

<Synthesis of Binder (Acrylic-Type Copolymer 1)>

30 parts of methacrylic acid, 50 parts of methyl methacrylate, 20 parts of ethyl methacrylate, and 500 parts of isopropyl alcohol and 3 parts of α,α′-azobis isobutyronitrile were put in a three-neck flask in the nitrogen gas flow, and were subjected to reaction in an oil bath having a temperature of 80° C. in the nitrogen gas flow for six hours. After that, ref lux was performed at the boiling point of isopropyl alcohol for one hour. Then 3 parts of triethyl ammonium chloride and 25 parts of glycidyl methacrylate were added to this mixture and were subjected to reaction for three hours, whereby acrylic-type copolymer 1 was produced. The weight average molecular weight measured by the GPC was about 35,000, and the glass transfer temperature (Tg) measured by the DSC (differential scanning calorimeter) was about 85° C.

(Manufacturing the Substrate)

An aluminum plate (material 1050, tempered to H16) having a thickness of 0.3 mm was immersed in an aqueous solution containing 5% sodium hydroxide kept at 65° C., and was degreased for one minute. After that, it was rinsed with water. This degreased aluminum plate was immersed in an aqueous solution containing 10% hydrochloric acid kept at 25° C. for one minute, was neutralized and was rinsed in water. Then this aluminum plate was treated by electrolytic roughening in an aqueous solution containing 0.3% nitric acid at 25° C. at a current density of 100 A/dm² for 60 seconds, using AC current. After that, the plate was subjected to a process of desmutting for 10 seconds in an aqueous solution containing 5% sodium hydroxide kept at 60° C. The roughened aluminum plate subjected the desmutting process was subjected to anodic oxidation in the solution containing 15% sulfuric acid at 25° C. at a current density of 100 A/dm² with a voltage of 15 volts for one minute. Further, the plate was provided with hydrophilic treatment at 75° C. using 1% polyvinyl phosphonic acid, whereby a substrate was produced.

In this case, the center line average roughness (Ra) on the surface was 0.65 μm.

<<Manufacturing the Printing Plate Material>

The photo-polymerizable photosensitive layer coating solution of the following composition was coated on the aforementioned substrate by a wire bar and dried at 95° C. for 1.5 minutes in such a way that the weight would be 1.5 g/m² when dried, whereby a photo-polymerizable photosensitive layer coating sample was obtained.

(Photo-Polymerizable Photosensitive Layer Coating Solution)

| | | |
|---|---|---|
| (Monomer containing the addition polymerizable | 25.0 | parts |
| ethylenic double bond: M-3 | | |
| (Monomer containing the addition polymerizable | 25.0 | parts |
| ethylenic double bond: NK ester 4G (polyethylene glycol | | |
| dimethacrylate by Shinnakamura Chemical Co., Ltd.) | | |
| Photo-polymerization initiator I-1 | 2.0 | parts |
| Photo-polymerization initiator I-2 | 2.0 | parts |
| Photo-polymerization initiator BR22 | 1.0 | part |
| Photo-polymerization initiator BR43 | 1.0 | part |
| Spectral sensitizing pigment D-5 | 1.5 | parts |
| Spectral sensitizing pigment D-7 | 1.5 | parts |
| Acrylic-type copolymer 1 | 40.0 | parts |
| N-phenylglycinebenzyl ester | 4.0 | parts |
| Phthalocyanine pigment (MHI454 by Mikuni Shikiso Co., | 6.0 | parts |
| Ltd.) | | |
| 2-t-butyl-6-(3-t-butyl-2-hydroxy-5-methylbenzyl)-4- | 0.5 | parts |
| methylphenylacrylate (Sumilizer GS by Sumitomo 3M | | |
| Co., Ltd.) | | |
| Fluorine system surface active agent (F-178K by | 0.5 | parts |
| Dainippon Ink and Chemicals Incorporated) | | |
| Methyl ethyl ketone | 80 | parts |
| Cyclohexanone | 820 | parts |

M-3: Reaction product of N-n-butyldiethanol amine (1 mol), 1,3-bis(1-isocyanate-1-methylethyl)benzene (2 moles) and 2-hydroxypropylene-1-methacrylate-3-acrylate (2 moles)

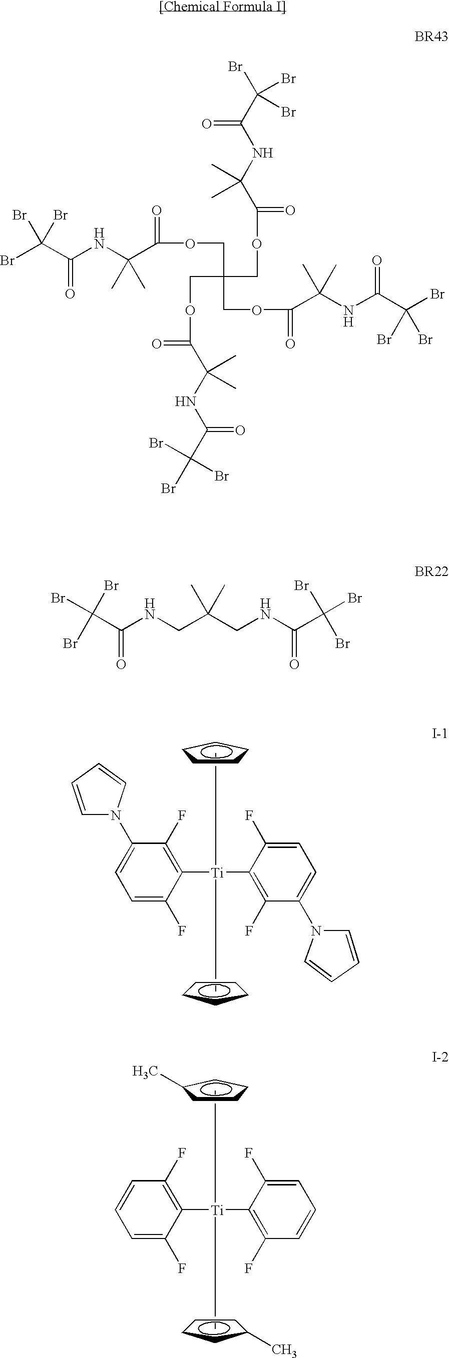

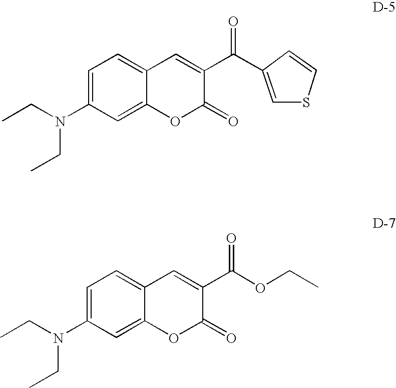

The oxygen blocking layer coating solution of the following composition was coated on the aforementioned photo-polymerizable photosensitive layer coating sample by using an applicator in such a way that the weight would be 1.8 g/m² when dried. The sample was dried at 75° C. for 1.5 minutes, whereby the printing plate material having an oxygen blocking layer on the photosensitive layer was manufactured.

(Oxygen Blocking Layer Coating Solution)

| | | |
|---|---|---|
| Polyvinyl alcohol (GL-05 by Nippon Synthetic Chemical | 89 | parts |
| Industry Co., Ltd.) | | |
| Water-soluble polyamide (P-70 by Toray Industries, | 10 | parts |
| Inc.) | | |
| Surface active agent (Surfinol 465 by Nisshin Chemical | 0.5 | parts |
| Industry Co., Ltd.) | | |
| Water | 900 | parts |
| (Formation of image) | | |

The printing plate material manufactured in the aforementioned manner was cut into a piece of 635×927 mm. The two-dimensional continuous gradation image having an area ratio of 35 through 85% based on the FM screen characterized by 20 μm dots equivalent to 385 lines as the image 1; the 8-pixel square checker board image as the image 2; and the scale that divides the aforementioned images 1 and 2 into 100 equal parts (the scale range is from 0 to 10) as the image 4 as a scale image were outputted to the non-print area (holding part), as shown in FIG. 2. This was subjected to exposure at a resolution of 2,400 dpi using the plate setter (Prosetter 74 by Heidelberg) having a light source of 405 nm, 60 mW.

At the same time, a halftone (50%) image based on the FM screen characterized by 20 μm dots equivalent to 385 lines was outputted to the printing area of the aforementioned printing plate material and exposure was carried out.

The image data used for the aforementioned image 1, image 2, image 4 and halftone (50%) image was edited by the image editing apparatus of FIG. 3, and was converted from the vector format to the raster format by the image screening apparatus of FIG. 4. The data was then sent to the exposure apparatus equipped with the aforementioned light source.

After exposure, development was carried out by the CTP automatic development apparatus (Raptor Polymer by Glunz & Jensen) equipped with a preheating section set to 105° C.; a pre-rinsing section for removing the oxygen blocking layer; a development section adjusted to a temperature of 30° C. and filled with a developer of the following composition; a rinsing section for removing the developer deposited on the plate surface; and a gum liquid (GW-3 obtained by doubling dilution the product made by Mitsubishi Chemical Corporation) processing section for protecting the printing area, whereby a planographic printing plate was obtained.

(Developer Composition)

| | |
|---|---|
| Potassium silicate A | 8.0 parts |
| Newcol B-13SN (by Nippon Nyukazai | 3.0 parts |
| Co., Ltd.) | |
| Water | 89.0 parts |
| Potassium hydroxide | the amount of addition to |
| | ensure that pH = 12.3 |

(Composition of Replenished Developer)

| | |
|---|---|
| Potassium silicate A | 8.0 parts |
| Newcol B-13SN (by Nippon Nyukazai | 3.0 parts |
| Co., Ltd.) | |
| Water | 89.0 parts |
| Potassium hydroxide | the amount of addition to |
| | ensure that pH = 12.7 |

<Evaluation>

The visibility for determining the equi-density position and the stability of the printing plate exposure and development process management were evaluated according to the following criteria.

(Visibility for Determining the Equi-Density Position)

The equi-density value was determined by visual observation using the image 1, image 2 and image 4 recorded in the non-print area of the printing plate material. Further, the value of the scale wherein the density difference can be recognized based on those of the image 1 and image 2 was measured by visual observation, and this was determined as the detectable scale value. The result is shown in table 1.

(Stability of Printing Plate Exposure and Development Process Management)

1,000 printing plates were outputted using the aforementioned planographic printing plate, image formation method, and exposure/development method. Based on the equi-density value of the printing plate used for the aforementioned visibility evaluation, the replenisher solution was replenished so as to get it back to the reference value of the equi-density value if the control range of Table 2 has been exceeded. Then the halftone dot ratio variation of the halftone image of the image 3 of each plate was measured, and the stability of the print quality was evaluated. “A” indicates that the variation was less than 2%, and “B” shows that the variation was 2% or more. The control range was set as shown in Table 2, according to the detectable scale value shown in Table 1. Table 2 shows the result.

### Comparative Example 1

Evaluation was made according to the same procedure as that of the Example except that a single line (one-dimensional) continuous gradation image having an area ratio of 35 through 85% based on the FM screen characterized by 20 μm dots equivalent to 385 lines was used as the image 1 of the aforementioned Example.

### Comparative Example 2

Evaluation was made according to the same procedure as that of the Example except that a single line (one-dimensional) non-continuous gradation image of 5% increment having an area ratio of 35 through 85% based on the FM screen characterized by 20 μm dots equivalent to 385 lines was used as the image 1 of the aforementioned Example, and the image wherein each 5%-increment pattern was assigned with a value in the range of 0 through 10 for each 5% increment was used as the image 4 without using a scale.

### Comparative Example 3

Evaluation was made according to the same procedure as that of the Example except that a single line (one-dimensional) non-continuous gradation image of 1% increment having an area ratio of 35 through 85% based on the FM screen characterized by 20 μm dots equivalent to 385 lines was used as the image 1 of the aforementioned Example, and the image wherein each 1%-increment pattern was assigned with a value in the range of 0 through 50 for each 1% increment was used as the image 4 without using a scale.

The results of evaluation are given in Tables 1 and 2.

TABLE 1

| | | | | Scale value | |
|---|---|---|---|---|---|
| | | | | detectable | |
| | | | Equidensity | by visual | |
| | Image 1 | Image 2 | value | observation | Remarks |
| Example | Two-dimensional continuous | 8-pixel | 5.24 | 0.01 | |
| | gradation image having an | square | | | |
| | area ratio of 35 through 85% | checker | | | |
| | based on the FM screen | board | | | |
| | characterized by 20 μm dots | | | | |
| | (equivalent to 385 lines) | | | | |
| Comparative | Single line (one-dimensional) | 8-pixel | 5.0 | 0.5 | |
| example 1 | continuous gradation image | square | | | |
| | having an area ratio of 35 | checker | | | |
| | through 85% based on the FM | board | | | |
| | screen characterized by 20 μm | | | | |
| | dots (equivalent to 385 lines) | | | | |
| Comparative | Non-continuous gradation | 8-pixel | 5 | 0.5 | |
| example 2 | image of 5% increments having | square | | | |
| | an area ratio of 35 through | checker | | | |
| | 85% based on the FM screen | board | | | |
| | characterized by 20 μm dots | | | | |
| | (equivalent to 385 lines) | | | | |
| Comparative | Non-continuous gradation | 8-pixel | — | — | Display |
| example 3 | image of 1% increments having | square | | | impossible |
| | an area ratio of 35 through | checker | | | in non- |
| | 85% based on the FM screen | board | | | image area |
| | characterized by 20 μm dots | | | | |
| | (equivalent to 385 lines) | | | | |

TABLE 2

| | | | | Equidensity | Variation of 50% | |
|---|---|---|---|---|---|---|
| | | | Number of | position | halftone dot area | |
| | | | times the | subsequent to | ratio during | |
| | | | developer | the output of | the output of | Stability |
| | Equidensity | Control | has been | 1,000 printing | 1,000 printing | of print |
| | value | range | replenished | plates | plates | quality |
| Example | 5.24 | 0.05 | 423 | 5.26 | ±1% | A |
| Comp. 1 | 5.0 | 0.5 | 45 | 5.0 | ±3% | B |
| Comp. 2 | 5.0 | 0.5 | 42 | 5.0 | ±4% | B |
| Comp. 3 | — | — | — | — | — | — |

Comp.: Comparative example

It has been demonstrated that, when printing a plurality of sheets containing high definition images, the plate making method of the present invention provides the printed matters characterized by a reduced variation of halftone dot area ratio and stable printing quality because of Tables 1 and 2.

With respect to Comparative Example 3, it was confirmed that if the image 1, the image 2 and the image 4 are provided according to this condition, the length in the longitudinal direction becomes too long and they cannot be displayed within the non-image area of the printing plate material.

In the aforementioned Example, the halftone dot area ratio variation is reduced by replenisher management. Further, the halftone dot area ratio variation can also be minimized by adjusting the temperature of a developer and the concentration of a replenisher.

High-precision management of the plate making process can be ensured by the aforementioned structure of the present invention. This invention, therefore, provides a plate making method, a printing plate image output apparatus, image editing apparatus and printing plate image output system wherein the printing plate manufactured by this method is capable of ensuring the prints of stable quality and maintaining the stable quality of the prints of high definition images in particular.

What is claimed is:

1. A plate making method for making a printing plate from a printing plate material, the plate making method comprising the steps of:
outputting, on the printing plate material, images based on a first control strip image data which form a pseudo gradation of two-dimensional direction having density gradation in a longitudinal direction and based on a second control strip image data which form a pseudo gradation having a uniform density in a longitudinal direction, the pseudo gradation having a uniform density being different from the pseudo gradation of two-dimensional direction of the first control strip image data; and
forming a first image based on the first control strip image data and a second image based on the second control strip image data on the printing plate based on the image outputting.

2. The plate making method of claim 1,
wherein the image outputting step further comprises a step of,
outputting an image based on print document image data in addition to the first control strip image data and the second control strip image data, and
wherein the image forming step further comprises a step of,
forming a third image based on the print document image data in addition to the first image and the second image.

3. The plate making method of claim 1,
wherein the image outputting step further comprises a step of,
outputting an image based on image data for a scale in addition to the first control strip image data and the second control strip image data, and
wherein the image forming step further comprises a step of,
forming a fourth image based on the image data for a scale in addition to the first image and the second image.

4. The plate making method of claim 1,
wherein the first image and the second image are adjacent to each other perpendicularly to a longitudinal direction.

5. The plate making method of claim 2,
wherein the fourth image is adjacent to the first image or the second image.

6. The plate making method of claim 1,
wherein the first image and the second image are in a non-image area of the printing plate.

7. The plate making method of claim 2,
wherein the first control strip image data, the second control strip image data and the print document image data are image data of a raster format and the image outputting step is conducted by an image output apparatus based on the image data of a raster format.

8. The plate making method of claim 7,
wherein the image data of a raster format is image data to which image data of a vector format has been converted by an image screening apparatus, the image data of a vector format having been edited by an image editing apparatus.

9. A printing plate image output apparatus used for the plate making method of claim 7, the printing plate image output apparatus conducting image output based on the first control strip image data which form pseudo gradation of two-dimensional direction having density gradation in a longitudinal direction, the second control strip image data which form pseudo gradation having a uniform density in a longitudinal direction, the pseudo gradation having a uniform density being different from the pseudo gradation of two-dimensional direction of the first control strip image data, and print document image data, all of which are image data of a raster format.

10. An image editing apparatus used for the plate making method of claim 8, the image editing apparatus attaching, to the print document image data, the first control strip image data which form a pseudo gradation of two-dimensional direction having density gradation in a longitudinal direction, and the second control strip image data which form a pseudo gradation having a uniform density in a longitudinal direction, the pseudo gradation having a uniform density being different from the pseudo gradation of two-dimensional direction of the first control strip image data.

11. An printing plate image output system, comprising:
an image editing apparatus for editing image data;
a screening apparatus for converting image data edited by the image editing apparatus; and
the printing plate image output apparatus of claim 9 for outputting an image based on the converted image data.

12. An printing plate image output system, comprising:
the image editing apparatus of claim 10 for editing image data;
a screening apparatus for converting image data edited by the image editing apparatus; and
an image output apparatus for outputting an image based on the converted image data.
